(19) United States
(12) Patent Application Publication
(10) Pub. No.: US 2018/0149907 A1
(43) Pub. Date: May 31, 2018

(54) AESTHETIC SURFACE AND DISPLAY DEVICE WITH SUCH A SURFACE

(71) Applicant: CORNING INCORPORATED, CORNING, NY (US)

(72) Inventors: Kevin Thomas Gahagan, Painted Post, NY (US); Jacques Gollier, Bellevue, WA (US); Dmitri Vladislavovich Kuksenkov, Elmira, NY (US)

(21) Appl. No.: 15/578,080

(22) PCT Filed: Jun. 1, 2016
(86) PCT No.: PCT/US16/35142

§ 371 Date: Nov. 29, 2017

Related U.S. Application Data
(60) Provisional application No. 62/169,815, filed on Jun. 2, 2015.

(51) Int. Cl. G02F 1/1335

(52) U.S. Cl. CPC G02F 1/133502; G02F 1/133512; G02F 2001/133567; G02F 1/133504; G02F 2001/133562; G02F 1/133526

(57) ABSTRACT

A display device (100) includes an image display unit (130), an aesthetic layer (144), and a focusing layer (142). The aesthetic layer (144) includes a matrix material (148) and an array of apertures (150) in the matrix material (148). The focusing layer (142) is disposed between the image display unit (130) and the aesthetic layer (144) and includes an array of optical elements (146) positioned to collectively focus an image generated by the image display unit (130) through the array of apertures (150) of the aesthetic layer (144).

This application claims the benefit of U.S. Provisional 62/169,815 filed on Jun. 2, 2015 the content of which is incorporated herein by reference in its entirety.

### BACKGROUND

### 1. Field

This disclosure relates to display devices, and more particularly to display devices with aesthetic surfaces configured to transmit images therethrough for viewing by a viewer.

### 2. Technical Background

Display devices generally include a plurality of pixels that generate an image. The pixels can emit light themselves (e.g., in an organic light emitting diode (OLED) display, a plasma display, or an electroluminescent (EL) display) or light can be emitted by a backlight and passed through the pixels (e.g., in a liquid crystal display (LCD)). The resulting image can be viewed directly by a viewer or projected onto a surface for viewing by the viewer.

### SUMMARY

Disclosed herein are display devices with aesthetic surfaces. The aesthetic surface can provide an external surface of the display device with a desirable appearance when the display device is in an off state and enable viewing of a viewable image therethrough when the display device is in an on state.

Disclosed herein is one exemplary display device comprising an image display unit, an aesthetic layer, and a focusing layer. The aesthetic layer comprises a matrix material and an array of apertures in the matrix material. The focusing layer is disposed between the image display unit and the aesthetic layer and comprises an array of optical elements positioned to collectively focus an image generated by the image display unit through the array of apertures of the aesthetic layer.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic view of one exemplary embodiment of a display device.

FIG. 2 is a front view of one exemplary embodiment of an aesthetic layer.

FIG. 3 is a front view of another exemplary embodiment of an aesthetic layer.

FIG. 4 is a schematic view of an exemplary embodiment of an aesthetic surface unit.

FIG. 5 is an illustration of one exemplary embodiment of a display device mounted in a vehicle.

FIG. 6 is a schematic view of an exemplary embodiment of an aesthetic surface unit.

FIG. 7 is a schematic view of another exemplary embodiment of an aesthetic surface unit.

FIG. 8 is a schematic view of another exemplary embodiment of a display device.

FIG. 9 is a schematic view of one exemplary embodiment of a collimating unit.

FIG. 10 is a schematic view of another exemplary embodiment of a collimating unit.

FIG. 11 is a schematic view of another exemplary embodiment of a display device.

FIG. 12 is a schematic view of another exemplary embodiment of a display device.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

In various embodiments, a display device comprises an image display unit and an aesthetic surface unit. The aesthetic surface unit comprises a focusing layer, and an aesthetic layer. The focusing layer comprises an array of optical elements. The aesthetic layer comprises a matrix material and an array of apertures in the matrix material. The array of apertures corresponds to the array of optical elements. For example, the array of apertures is positioned to collectively focus an image generated by the image display unit through the array of apertures of the aesthetic layer. In some embodiments, the display device comprises a diffusing unit (e.g., between the array of optical elements and the aesthetic layer and/or within the apertures of the aesthetic layer). The focusing layer is disposed between the image display unit and the aesthetic layer. In some embodiments, the image display unit comprises an array of pixels. In some of such embodiments, the focusing layer and the image display unit are arranged such that each optical element of the focusing layer is aligned with at least one corresponding pixel of the image display unit.

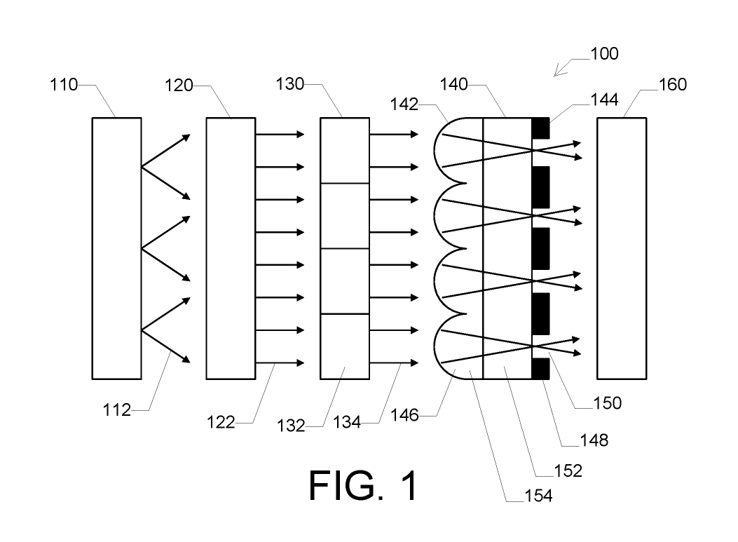

FIG. 1 is a schematic view of one exemplary embodiment of a display device 100. Display device 100 comprises a light unit comprising a light emitting unit 110 and a collimating unit 120. Display device 100 comprises an image display unit 130 and aesthetic surface unit 140. It will be understood that adjacent components of display device 100 can be adhered to each other (e.g., by an optically clear adhesive), secured within a bezel or frame (with or without an air gap therebetween), or coupled by another suitable coupling mechanism.

Light emitting unit 110 comprises one or more light sources each configured to emit light. For example, the light source comprises a light emitting diode (LED), an organic light emitting diode (OLED), a halogen light, an incandescent light, or another suitable light source. In some embodiments, light emitting unit 110 comprises a plurality of LEDs arranged in a 2-dimensional (2D) array. In another embodiment, light emitting unit 110 comprises a light bar adjacent to a light guiding sheet and comprising a row (e.g., a 1-dimensional array) of LEDs. The light bar emits light into an edge of the light guiding sheet, and the light guiding sheet disperses and emits the light from a surface of the light guiding sheet. In some embodiments, light emitting unit 110 emits non-collimated light 112.

Collimating unit 120 is positioned adjacent to light emitting unit 110 such that light emitted from the light emitting unit is incident on the collimating unit. Collimating unit 120 is configured to collimate the light emitted by light emitting unit 110. For example, non-collimated light 112 emitted from light emitting unit 110 passes through collimating unit 120 to form collimated light 122. Collimating unit 120 comprises a cylindrical lens, a Fresnel lens, or another suitable collimating device. For example, in some embodiments, collimating unit 120 comprises an array of Fresnel lenses.

Although collimating unit 120 is shown in FIG. 1 as being separate from light emitting unit 110, other embodiments are included in this disclosure. In some embodiments, the collimating unit is integral with the light emitting unit. For example, an output surface of the light emitting unit comprises an integral collimating unit. Thus, the light unit is configured as a collimated light unit.

Image display unit 130 is positioned adjacent to collimating unit 120 such that collimated light 122 emitted from the collimating unit is incident on the image display unit. Image display unit 130 comprises an array of display pixels 132. For example, the array of display pixels 132 comprises a 2D array having suitable x and y dimensions to display an image of a desired size. Each display pixel 132 comprises a light valve configured to control the passage of light therethrough. For example image display unit 120 comprises an LCD panel, and the array of display pixels 132 comprises an array of LCD cells. Each LCD cell is configured to open and close to control the passage of light therethrough. In some embodiments, each display pixel 132 is divided into a plurality of sub-pixels each associated with a dedicated display color component (e.g., red, green, or blue). Color images can be generated by using adjacent red, green, and blue sub-pixels. In some embodiments, collimated light 122 passes through a display pixel 132 of image display unit 130 to form an image pixel 134. For example, collimated light 122 passes through a plurality of display pixels 132 of image display unit 130 to form a plurality of image pixels 134 that cooperatively generate a viewable image. In some embodiments, image display unit 130 comprises one or more polarizing layers (e.g., input and output polarizers).

Collimating the light emitted by light emitting unit 110 prior to passing the light through image display unit 120 (e.g., by positioning collimating unit 120 between the light emitting unit and the image display unit) can aid in increasing the intensity or brightness of the viewable image relative to a conventional display device. Thus, in some embodiments, display device 100 comprises an output brightness or luminance of at least about 500 cd/m², at least about 600 cd/m², at least about 700 cd/m², at least about 800 cd/m², at least about 900 cd/m², at least about 1000 cd/m², at least about 1100 cd/m², at least about 1200 cd/m², at least about 1300 cd/m², at least about 1400 cd/m², or at least about 1500 cd/m².

Aesthetic surface unit 140 is positioned adjacent to image display unit 130 such that light that is emitted from the image display unit is incident on the aesthetic surface unit. In some embodiments, aesthetic surface unit 140 is configured as an aesthetic surface sheet. The aesthetic surface sheet can be substantially flat or planar. Alternatively, the aesthetic surface sheet can be non-planar. For example, the aesthetic surface sheet can be curved, rolled (e.g., into a tube), bent (e.g., at one or more edges), or formed into another non-planar configuration. Aesthetic surface unit 140 comprises a focusing layer 142 and an aesthetic layer 144. In the embodiment shown in FIG. 1, a first major surface of aesthetic surface unit 140 comprises focusing layer 142 and a second major surface of the aesthetic surface unit comprises aesthetic layer 144. Thus, aesthetic surface unit 140 comprises a unitary aesthetic surface unit. In other embodiments, the focusing layer and the aesthetic layer can be independent layers arranged to function as described herein. Focusing layer 142 comprises an array of optical elements 146. Aesthetic layer 144 comprises a matrix material 148 and an array of apertures 150 in the matrix material. The array of apertures 150 corresponds to the array of optical elements 146. For example, each optical element 146 is aligned with at least one aperture 150.

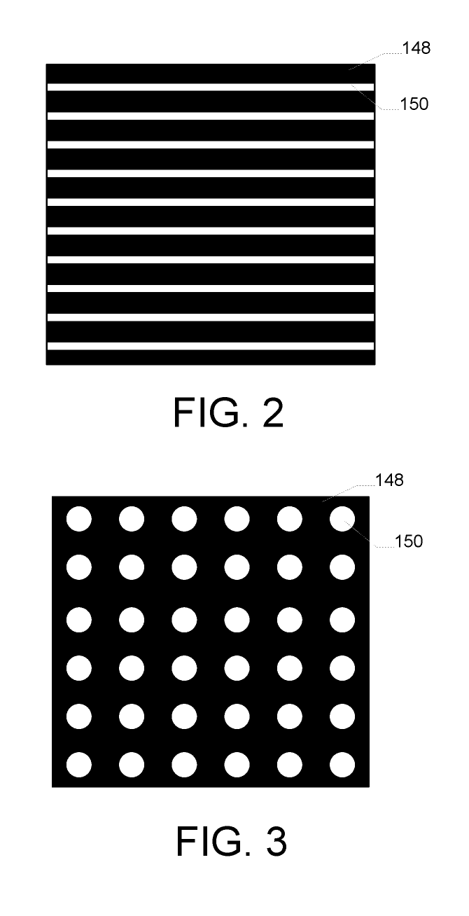

In some embodiments, optical elements 146 comprise microlenses as shown in FIG. 1. The microlenses are configured as lenticular lenses, spherical lenses, aspherical lenses, another suitable lens shape, or combinations thereof. For example, in some embodiments, the microlenses are configured as lenticular lenses extending at least partially across a width and/or a length of the aesthetic surface unit. In other embodiments, the microlenses are configured as spherical lenses dispersed about the width and/or length of the aesthetic surface unit (e.g., in a 2-dimensional array). Additionally, or alternatively, apertures 150 have a circular shape, a rectangular shape, another suitable shape, or combinations thereof. For example, FIG. 2 is a front view of one exemplary embodiment of aesthetic layer 144 with elongate rectangular apertures 150 formed in matrix material 148. The apertures have an elongate rectangular shape extending at least partially across a width and/or a length of the aesthetic layer. Thus, the elongate apertures can be aligned with lenticular microlenses. FIG. 3 is a front view of another exemplary embodiment of aesthetic layer 144 with circular apertures 150 formed in matrix material 148. The apertures have a circular shape and are dispersed about the width and/or length of the aesthetic layer. Thus, the circular apertures can be aligned with spherical microlenses. In various embodiments, the shape and/or placement of the apertures corresponds to the configuration and/or placement of the microlenses.

Although optical elements 146 of the embodiment shown in FIG. 1 are described as comprising microlenses, other embodiments are included in this disclosure. In some embodiments, the optical elements comprise mirrors. For example, one or more of the mirrors is configured as a parabolic reflector cavity with the mouth of the cavity (e.g., the wider end) facing the image display unit and an opening formed through the parabolic reflector cavity opposite the mouth (e.g., in the narrow end) and aligned with the corresponding aperture of the aesthetic layer.

Aesthetic surface unit 140 and image display unit 130 are arranged such that the array of optical elements 146 is disposed between the image display unit and aesthetic layer 148. Thus, the first major surface comprises an input surface of aesthetic surface unit 140, and the second major surface comprises an output surface of the aesthetic surface unit. Light that passes through image display unit 130 enters aesthetic surface unit 140 through the first major surface and exits the aesthetic surface unit through the second major surface to transmit the viewable image for viewing by a viewer. In some embodiments, image display unit 130 and aesthetic surface unit 140 are arranged such that an optical element 146 focuses an image pixel 134 on a corresponding aperture 150. For example, the plurality of image pixels 134 transmitted by image display unit 130 is focused by the array of optical elements 146 on the array of apertures 150 so that the image pixels pass through the apertures in the aesthetic layer 144 to transmit the viewable image through the aesthetic layer for viewing by the viewer. In some embodiments, a thickness of aesthetic layer 144 is at most about 125%, at most about 120%, at most about 115%, at most about 110%, at most about 105% of a size (e.g., a diameter of a circular aperture or a width of a rectangular aperture) of apertures 150. For example, the thickness of aesthetic layer 144 is less than or equal to the size of apertures 150.

Although image display unit 130 shown in FIG. 1 is described as comprising pixels 132 comprising light valves, other embodiments are included in this disclosure. In some embodiments, the image display unit comprises a plurality of pixels each comprising an emissive element. For example, the emissive element comprises an LED, a microLED, an OLED, a plasma cell, an electroluminescent (EL) cell, or another suitable element configured to emit radiation. In some embodiments, the emissive element is configured as a point light source. For example, the point light source comprises an LED, an OLED, or another suitable emissive element configured to emit radiation from a small surface area. In embodiments in which the image display unit comprises a plurality of pixels each comprising an emissive element, the display pixels themselves emit light to generate the viewable image. Thus, the light unit can be omitted. Additionally, or alternatively, the collimating unit can be positioned between the image display unit and the aesthetic surface unit (e.g., to collimate light emitted by the emissive elements of the image display unit). In some embodiments, the image display unit and the aesthetic surface unit are arranged such that an optical element of the focusing layer focuses an image pixel generated by the image display unit on a corresponding aperture of the aesthetic layer. For example, a plurality of image pixels emitted by the image display unit is focused by the array of optical elements on the array of apertures so that the image pixels pass through the apertures in the aesthetic layer to transmit the viewable image through the aesthetic layer for viewing by the viewer.

Although display device 100 shown in FIG. 1 is configured as a direct view display device in which the image generated by backlight unit 110 and image display unit 130 is viewable directly by a user without being projected onto a screen, other embodiments are included in this disclosure. In other embodiments, the display device comprises a projection display device in which an image generated by the backlight unit and the image display unit, or the image display unit without a backlight unit, is projected onto a screen. In such embodiments, the aesthetic surface unit can serve as the screen upon which the image is projected.

Image display device 100 is switchable between an on state in which an image is generated by image display unit 110 and transmitted through aesthetic layer 144 and an off state in which no image is generated by the image display unit and transmitted through the aesthetic layer. In some embodiments, the appearance of an external surface of image display device 100 (e.g., the output surface of aesthetic surface unit 140 viewed from a viewing position) is at least partially determined by the properties of the aesthetic layer. Thus, the area occupied by apertures 150 is relatively small. For example, apertures 150 occupy at most about 50%, at most about 40%, at most about 30%, at most about 20%, at most about 10%, at most about 5%, or at most about 1% of a surface area of aesthetic layer 144. Limiting apertures 150 to such a small portion of the surface area of aesthetic layer 144 can render the apertures substantially invisible to the naked eye. Thus, with display device 100 in the off state, the external surface of the display device has the appearance to a viewer of matrix material 148. However, switching display device 100 to the on state results in transmission of the image through apertures 150 such that the external surface of the display device has the appearance of the image to the viewer. Thus, when viewing display device 100 in the off state, the viewer sees matrix material 148 of aesthetic layer 144, and when viewing the display device in the on state, the viewer sees the image transmitted through apertures 150 in the aesthetic layer.

In some embodiments, an outer surface of matrix material 148 comprises a substantially solid color. For example, the substantially solid color comprises black, white, red, green, blue, another color, or combinations thereof. Thus, with display device 100 in the off state, the external surface of the display device appears to a viewer to be a solid surface having the solid color. In other embodiments, an outer surface of matrix material 148 comprises a decorative pattern. For example, the decorative pattern comprises a wood grain pattern, a leather textured pattern, a fabric textured pattern, a metallic textured pattern (e.g., brushed, polished, or diamond plate), a carbon fiber textured pattern, another suitable pattern or design, or combinations thereof. Thus, with display device 100 in the off state, the external surface of the display device appears to a viewer to be a solid surface having the decorative pattern. Matrix material 148 can comprise a substantially homogeneous material or an inhomogeneous material. For example, the inhomogeneous material comprises a multilayer material. Matrix material 148 can comprise a homogeneous material having the solid color or decorative pattern or a multilayer material with an outer layer having the solid color or decorative pattern.

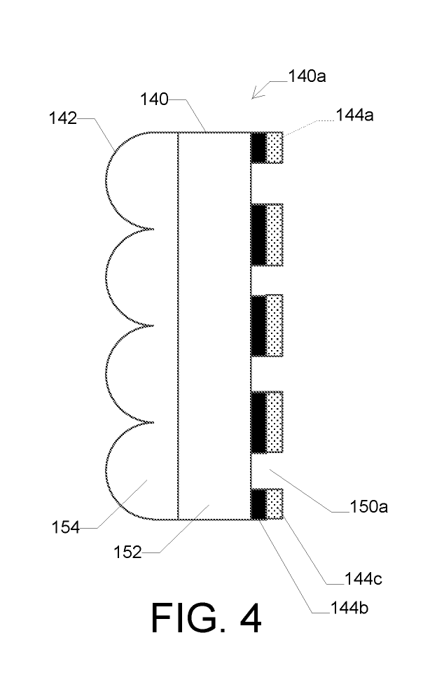

FIG. 4 is a schematic view of an exemplary embodiment of an aesthetic surface unit 140a. Aesthetic surface unit 140a is similar to aesthetic surface unit 140 described with respect to FIG. 1. For example, aesthetic surface unit 140a comprises focusing layer 142 and an aesthetic layer 144a. In the embodiment shown in FIG. 4, aesthetic layer 144a comprises a multilayer material comprising an inner layer 144b and an outer layer 144c. Inner layer 144b comprises a light absorbing material. The light absorbing material 148a can comprise a matrix material as described herein with regard to the embodiment shown in FIG. 1. Outer layer 144c comprises a decorative layer (e.g., comprising a decorative pattern as described herein). Aesthetic layer 144a comprises an array of apertures 150a therein. For example, apertures 150a extend entirely through aesthetic layer 144a (e.g., through both inner layer 144b and outer layer 144c). In use, light that passes through image display unit 130 enters aesthetic surface unit 140a through the first major surface and exits the aesthetic surface unit through the second major surface to transmit the viewable image for viewing by a viewer.

The aesthetic surface unit can help to improve the contrast of the display device in two different ways—by reduce the amount of ambient light that the display device reflects and/or scatters and also by reducing the amount of stray light inside the display device that is able to escape. Both lead to an improved (e.g., darker) black level, and therefore, higher contrast for the same white level. Stray light inside the display device can be described as any light that is not completely blocked by a light valve (e.g., LCD cell) when it is in a fully “closed” or 100% “black” state. For example, stray light may include light at angles that are too high to be entirely polarized by a bottom or input polarizer of the display unit, and therefore, is not completely blocked by the top or output polarizer, or light that is scattered by the driving TFT structures and directed through the light valve at directions or angles such that the polarization does not turn full 90 degrees, for the same effect. The aesthetic surface unit can help to reduce stray light by blocking any light rays that are not collimated at the aesthetic layer (e.g., after passing through the focusing layer). However, in embodiments in which the aesthetic layer is not completely or substantially completely absorbing (e.g., not black), some stray light might be able to get through the aesthetic layer. In some of such embodiments, the aesthetic layer comprises multiple layers (e.g., inner and outer layers 144b and 144c as described herein with respect to FIG. 4). The inner layer can comprise a light absorbing layer (e.g., a black layer). Additionally, or alternatively, the outer layer can comprise a decorative layer (e.g., to provide a desired aesthetic character in reflection). Thus, the inner layer can absorb stray light to provide the contrast improvements, and the outer layer can provide the desired aesthetic appearance. The total thickness of the multiple layers (e.g., the total thickness of the multi-layer aesthetic layer) can be only slightly larger, or less than or equal to, the size of the apertures as described herein.

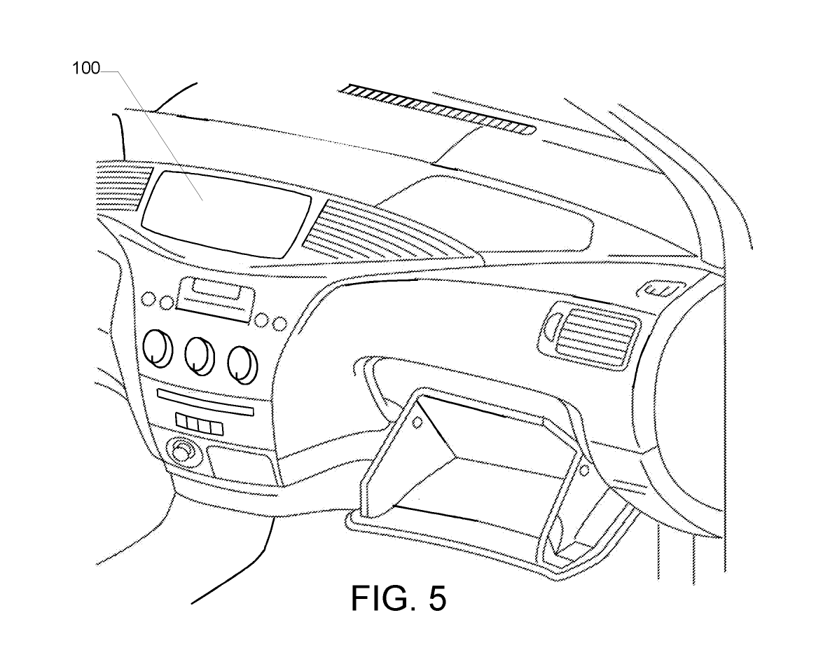

The solid color or decorative pattern of matrix material 148 can enable display device 100 in the off state to be substantially indistinguishable from or coordinated with a surrounding environment. In some embodiments, display device 100 can be mounted such that the exterior surface of the display device is integral with or forms a portion of a surface. For example, the surface can be a surface of a vehicle (e.g., an automobile, a boat, an airplane, or another vehicle), an appliance (e.g., a refrigerator, an oven, a stove, or another appliance), a wall (e.g., an internal or external wall of a building), or another suitable surface. The solid color or decorative pattern of matrix material 148 can be substantially the same as or coordinated with that of the surface such that display device 100 in the off state is substantially indistinguishable from or coordinated with the surface. FIG. 5 is an illustration of one exemplary embodiment of display device 100 mounted in a vehicle such that the exterior surface of the display device is integral with a dashboard of the vehicle. In some embodiments, the solid color or decorative pattern of matrix material 148 is substantially the same as that of the dashboard such that display device 100 in the off state blends in to the dashboard. However, switching display device 100 to the on state enables transmission of an image through apertures 150, giving an illusion that the image is being generated by the dashboard. In various embodiments, the surface of the vehicle can be a dashboard, a console, a door panel, a pillar, a seat (e.g., a rear surface of a headrest), or another suitable vehicle surface.

In some embodiments, aesthetic layer 144 can help to enhance the contrast of display unit 100. Ambient light (e.g., from the sun, room lighting, or another light source) can fall on aesthetic surface unit 140 from the viewing side. In other words, ambient light from outside display device 100 can fall on the second major surface of aesthetic surface unit 140. In some embodiments, matrix material 148 of aesthetic layer 144 absorbs at least a portion of such ambient light that falls on the aesthetic layer outside of apertures 150. For example, matrix material 148 comprises a high optical density (e.g., a black matrix resin material). Such absorption of ambient light can increase the contrast of display device 100 (e.g., because the absorbed ambient light is not reflected to interfere with the light emitted from the aesthetic surface unit as a viewable image).

In the embodiment shown in FIG. 1, aesthetic surface unit 140 comprises a substrate 152. For example, substrate 152 comprises a glass substrate. Such a glass substrate can enable improved dimensional stability (e.g., reduced deformation resulting from changes in environmental conditions such as temperature and/or humidity) as compared to a polymer substrate. Such improved dimensional stability can aid in maintaining alignment between the array of display pixels and the array of optical elements at varying environmental conditions, which can help to prevent, for example, Moire patterns, even in embodiments in which the pixel pitch of the image display unit and the pitch of the optical elements are not equal. In other embodiments, substrate 152 comprises a polymer material or another suitable substrate material. A resin layer 154 is disposed on a surface of substrate 152, and the array of optical elements 146 is formed in the resin layer. For example, the array of optical elements 146 can be formed using a microreplication process, an embossing process, or another suitable forming process. In other embodiments, the array of optical elements is formed directly in the substrate. For example, the array of optical elements can be formed by embossing or machining the surface of the substrate. In some embodiments, aesthetic layer 144 comprises matrix material 148 disposed on a surface of substrate 152 opposite the array of optical elements 146. In some embodiments, substrate 152 comprises a glass substrate having a thickness of at most about 300 μm, at most about 250 μm, at most about 150 μm, at most about 120 μm, at most about 110 μm, or at most about 100 μm. Such a thin glass substrate can enable a reduced thickness of the display device without sacrificing dimensional stability.

In some embodiments, the substrate comprises a plurality of substrates. For example, the substrate comprises a first substrate with optical elements disposed on a surface thereof and a second substrate with the aesthetic layer disposed on a surface thereof. The first and second substrates can be positioned adjacent to each other to form the aesthetic surface unit comprising the substrate with optical elements and the aesthetic layer disposed on opposing surfaces thereof.

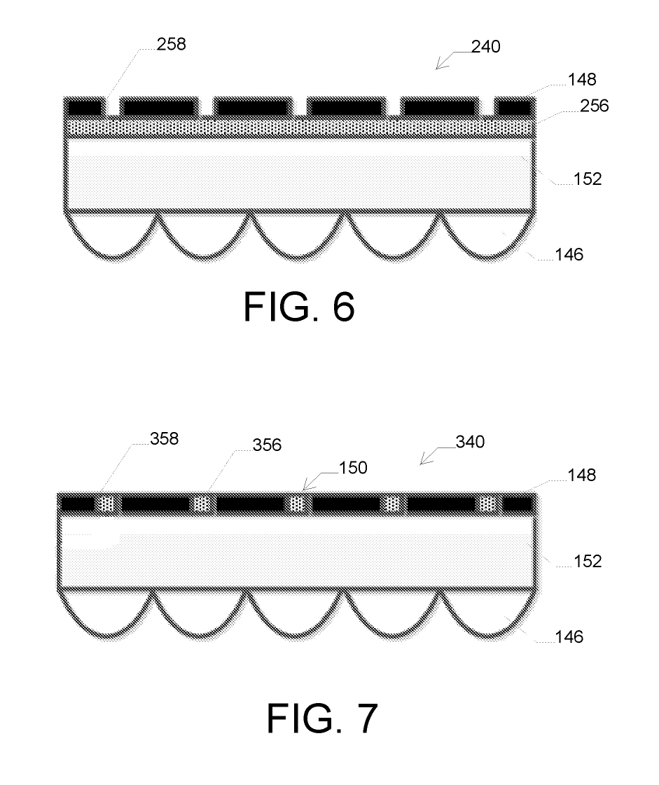

In some embodiments, the aesthetic surface unit comprises a diffusing unit. The diffusing unit is configured to scatter light that passes therethrough to increase the diffusion angle of the light. For example, the diffusing unit can comprise a light scattering material. FIG. 6 is a schematic view of an exemplary embodiment of an aesthetic surface unit 240, which is similar to aesthetic surface unit 140 described herein with reference to FIG. 1. In the embodiment shown in FIG. 6, aesthetic surface unit 240 comprises a diffusing unit 256 configured as a diffusing layer disposed between optical elements 146 and light absorbing layer 148. For example, diffusing unit 256 is disposed between substrate 152 and aesthetic layer 144 as shown in FIG. 6. FIG. 7 is a schematic view of an exemplary embodiment of an aesthetic surface unit 340, which is similar to aesthetic surface unit 140 described herein with reference to FIG. 1. In the embodiment shown in FIG. 7, aesthetic surface unit 340 comprises a diffusing unit 356 configured as diffusing material disposed within one or more apertures 150 in aesthetic layer 144. For example, one or more apertures 150 can be filled with diffusing material to form diffusing member 356 within the apertures. In some embodiments, diffusing unit 356 is disposed within each aperture 150 as shown in FIG. 7. The diffusing unit can help to increase the viewing angle of the display device.

In some embodiments, the diffusing unit is integral with the substrate of the aesthetic surface unit. For example, a surface of the substrate (e.g., the surface upon which the optical elements are formed and/or the surface upon which the aesthetic layer is formed) comprises a roughened surface that diffuses light passing therethrough. Thus, the diffusing unit comprises the roughened surface of the substrate.

In some embodiments, aesthetic layer 144 comprises a light absorbing border disposed at an edge of one or more of the apertures 150 thereof (e.g., light absorbing border 258 shown in FIG. 6 or light absorbing border 358 shown in FIG. 7).

Additionally, or alternatively, the light absorbing border extends at least partially around a circumference of the edge. The light absorbing border can comprise a layer (e.g., an annulus or ring) of light absorbing material (e.g., black matrix resin) disposed on an inner surface of the edge of one or more apertures 150. The light absorbing border can help to prevent light from scattering within aesthetic layer 144 instead of being transmitted through the aesthetic layer for viewing by the viewer. Such scattering within the aesthetic layer can cause distortion of the image. In some embodiments, aesthetic layer 144 comprises a translucent layer covering at least a portion of the outer surface of matrix material 148. Such a translucent layer can help to reduce glare from the outer surface of the matrix material without substantially modifying the appearance of the aesthetic surface. The light absorbing border and/or the translucent layer may be beneficial in embodiments in which the matrix material is not substantially light absorbing. For example, in embodiments in which the matrix material comprises a non-black color, the light absorbing border and/or the translucent layer may help to improve image quality by reducing undesirable scattering of light.

In some embodiments, display device 100 comprises a transparent cover 160. Transparent cover 160 comprises a glass substrate (e.g., a soda lime glass, an alkali aluminosilicate glass, and/or an alkali aluminoborosilicate glass), a polymer substrate (e.g., polycarbonate), or another suitable substrate. Transparent cover 160 is disposed on an outer surface of display device 100. Transparent cover 160 can comprise a planar (e.g., a flat sheet) or a non-planar (e.g., a curved sheet) configuration. In some embodiments, transparent cover 160 comprises an anti-glare (AG) and/or an anti-reflective (AR) coating on an outer surface of the transparent cover. Transparent cover 160 can comprise a strengthened (e.g., thermally strengthened, mechanically strengthened, and/or chemically strengthened) glass, which can aid in protecting the other components of display device 100 from scratching and/or breakage.

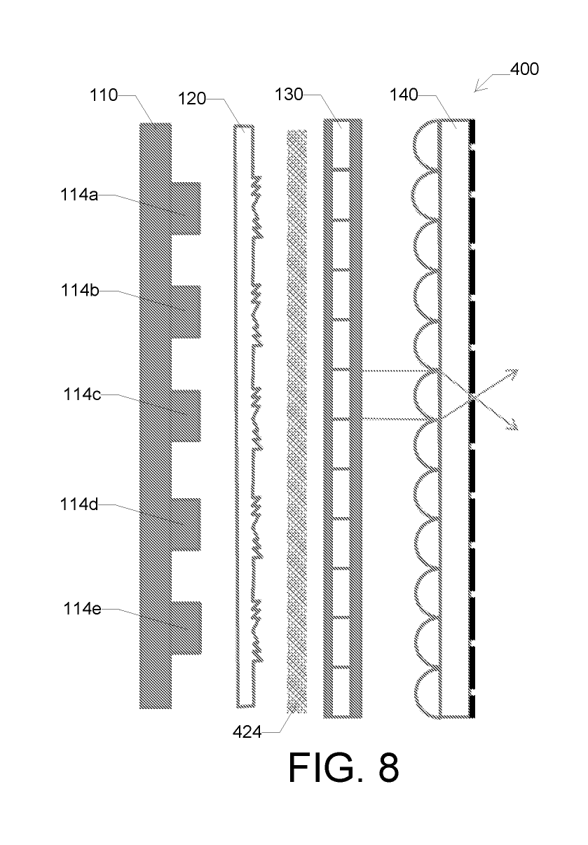

FIG. 8 is a schematic view of an exemplary display device 400. Display device 400 is similar to display device 100 described in reference to FIG. 1. For example, Display device 400 comprises a light unit, image display unit 130, and aesthetic surface unit 140. The light unit comprises light emitting unit 110 and collimating unit 120. In the embodiment shown in FIG. 8, light unit comprises a diffusing unit 424.

In some embodiments, light emitting unit 110 comprises a series 114a of light sources. Series 114a of light sources is arranged in a row extending in a first direction. For example, the first direction is shown in FIG. 8 as the z direction extending into the drawing. In some embodiments, the row is substantially linear as shown in FIG. 8. In other embodiments, the row is curved (e.g., for use in a curved display device). In some embodiments, series 114a of light sources is configured as a light bar comprising a plurality of LEDs or OLEDs.

Collimating unit 120 is disposed adjacent to series 114a of light sources. For example, collimating unit 120 extends substantially parallel to the row. Collimating unit 120 is configured to collimate the light emitted by series 114a of light sources in a second direction substantially perpendicular to the row without collimating the light in the first direction substantially parallel to the row. The collimated light comprises a divergence angle of less than 10 degrees in the direction or directions in which the light is collimated. For example, the second direction is shown in FIG. 8 as the x direction (e.g., a vertical direction in the orientation shown in FIG. 8). Collimating unit 120 comprises a collimating lens aligned with series 114a of light sources. For example, the collimating lens comprises a cylindrical lens, a cylindrical Fresnel lens, another suitable lens, or a combination thereof. In some embodiments, collimating unit 120 is spaced from series 114a of light sources by a distance that is substantially equal to a focal length of the collimating unit. For example, the distance between a top surface of each individual light source of series 114a and collimating unit 120 (e.g., in the y direction) is substantially equal to the focal length of the collimating unit.

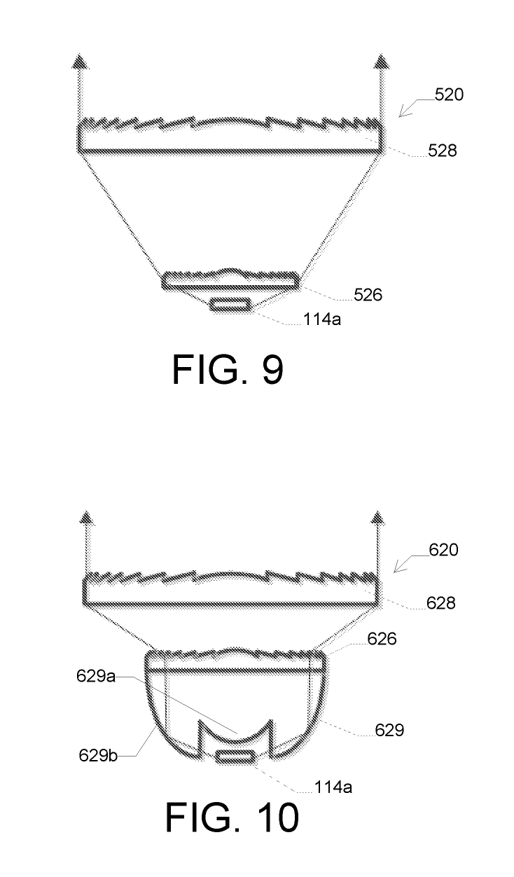

In the embodiment shown in FIG. 8, collimating unit 120 comprises a cylindrical Fresnel lens. FIG. 9 is a schematic view of another exemplary embodiment of a collimating unit 520. Collimating unit 520 comprises a conditioning element 526 and a collimating element 528. Collimating unit 520 is arranged such that conditioning element 526 is disposed between series 114a of light sources and collimating element 528. In some embodiments, the light emitted by series 114a of light sources comprises wide-angle light having a substantially Lambertian angular intensity distribution in the second direction. In some embodiments, in the Lambertian angular intensity distribution, light power traveling in different directions is not uniform, but rather is proportional to the cosine of an angle to a surface (e.g., a light source surface) normal. Conditioning element 526 is configured to transform the wide-angle light into uniform light having a substantially uniform angular intensity distribution in the second direction at a reference plane spaced from the conditioning element. It can be beneficial to position the collimating unit at the reference plane such that the collimating unit is substantially uniformly illuminated by the uniform light. For example, conditioning element 526 comprises a cylindrical lens, a Fresnel lens (e.g., a cylindrical Fresnel lens), another suitable lens, or a combination thereof. Collimating element 528 is configured to collimate the uniform light in the second direction. For example, collimating unit 528 comprises a cylindrical lens, a Fresnel lens (e.g., a cylindrical Fresnel lens), another suitable lens, or a combination thereof. The conditioning element can help to illuminate the collimating element uniformly across a surface of the collimating element, which can help to reduce the potential for brightness non-uniformity in the image generated by the display device that may be caused by the Lambertian output of the series of light sources.

FIG. 10 is a schematic view of another exemplary embodiment of a collimating unit 620. Collimating unit 620 comprises a conditioning element 626, a collimating element 628, and a concentrating element 629. Collimating unit 620 is arranged such that conditioning element 626 is disposed between series 114a of light sources and collimating element 628, and concentrating element 629 is disposed between the series of light sources and the conditioning element. Concentrating element 629 is configured to concentrate the Lambertian light emitted by the series 114a of light sources onto conditioning element 626. For example, concentrating element 629 comprises a refractive portion 629a and a reflective portion 629b. In some embodiments, refractive portion 629a comprises a lens portion to direct light toward conditioning element 629. Additionally, or alternatively, reflective portion 629b comprises a mirror surface to direct light toward conditioning element 629. In some embodiments, concentrating element 629 comprises a molded refractive/reflective type collimator. Conditioning element 626 is configured to transform the Lambertian light emitted by series 114a of light sources into uniform light having a substantially uniform intensity distribution in the second direction. For example, conditioning element 626 comprises a cylindrical lens, a Fresnel lens (e.g., a cylindrical Fresnel lens), another suitable lens, or a combination thereof. Collimating element 628 is configured to collimate the uniform light in the second direction. For example, collimating unit 628 comprises a cylindrical lens, a Fresnel lens (e.g., a cylindrical Fresnel lens), another suitable lens, or a combination thereof. The concentrating element can help to collect a relatively large portion of the light emitted by the series of light sources and direct the light to the conditioning element. For example, in some embodiments, the concentrating element is configured to collect and/or at least partially collimate up to about 80% of the light emitted by the series of light sources. The conditioning element can help to illuminate the collimating element uniformly across a surface of the collimating element, which can help to reduce the potential for brightness non-uniformities in the image generated by the display device.

Although the collimating units shown in FIGS. 7-9 are described as 1-dimensional collimating units comprising, for example, cylindrical and/or cylindrical Fresnel lenses, other embodiments are included in this disclosure. For example, in other embodiments, the collimating unit is configured as a 2-dimensional collimating unit comprising a spherical and/or aspherical Fresnel lens. In various embodiments, the shape of the collimating unit may correspond to the shape of the optical elements of the aesthetic surface unit. For example, a 1-dimensional collimating unit may be used with an aesthetic surface unit comprising lenticular lenses. Additionally, or alternatively, a 2-dimensional collimating unit may be used with an aesthetic surface unit comprising spherical and/or aspherical lenses.

Diffusing unit 424 is disposed adjacent to series 114a of light sources as shown in FIG. 8. For example, diffusing unit 424 is configured to diffuse the light emitted by the series of light sources in the first direction substantially parallel to the row (e.g., the z direction) without diffusing the light in the second direction substantially perpendicular to the row (e.g., the x direction). Thus, diffusing unit 424 comprises a 1-dimensional diffuser. In some embodiments, the diffusing unit comprises a plurality of small refractive or reflective elements, each of which deflects a light beam by a random angle between zero and a determined diffusion angle. If such angles are parallel to only one axis, then the diffusing unit functions as a 1-dimensional diffuser. If such angles form a cone or a portion of a cone with some angles along one axis and some angles along another perpendicular axis, then the diffusing unit functions as a 2-dimensional diffuser. The diffusing unit can help to homogenize the illumination of the display device. For example, the diffuser can be engineered to leave the light collimated in one direction, but diffuse the light in the other direction, such that a viewer of the display device will not see bright lines (corresponding to the individual light source positions) separated by dark spaces.

Diffusing unit 424 is disposed between light emitting unit 110 and aesthetic surface unit 140. For example, diffusing unit 424 is disposed between collimating unit 120 and aesthetic surface unit 140 and/or between the collimating unit and image display device 130. In some embodiments, collimating unit 120 is disposed between light emitting unit 110 and diffusing unit 424 as shown in FIG. 8. Such a configuration can aid in properly spacing the diffusing unit from the light emitting unit without unnecessarily increasing the thickness of the display device.

In some embodiments, diffusing unit 424 extends substantially parallel to series 114a of light sources and is spaced from the series of light sources. For example, series 114a of light sources comprises a first light source and a second light source disposed directly adjacent to the first light source and spaced from the first light source by a distance X (e.g., in the z direction). Diffusing unit 424 is spaced from series 114a of light sources by a distance Y (e.g., in the y direction). For the diffusing unit to be efficient in achieving brightness uniformity, the diffusion angle should be greater than the angular size of the gap between individual light sources, visible from the diffuser position. For example, diffusing unit 424 comprises a diffusion angle θ that satisfies the formula: θ>arctan(X/Y).

Although the diffusing unit shown in FIG. 8 is described as 1-dimensional diffusing unit that diffuses light in one direction, other embodiments are included in this disclosure. For example, in other embodiments, the diffusing unit is configured as a 2-dimensional diffusing unit configured to diffuse light in two perpendicular directions. In various embodiments, the configuration of the diffusing unit may correspond to the shape of the optical elements of the aesthetic surface unit and/or the configuration of the collimating unit. For example, a 1-dimensional diffusing unit may be used with an aesthetic surface unit comprising lenticular lenses and/or with a 1-dimensional collimating unit. Additionally, or alternatively, a 2-dimensional diffusing unit may be used with an aesthetic surface sheet comprising spherical and/or aspherical lenses and/or with a 2-dimensional collimating unit.

In some embodiments, display device 400 comprises multiple series of light sources. For example, in the embodiment shown in FIG. 8, display device 400 comprises a second series 114b of light sources directly adjacent to series 114a. Second series 114b of light sources is arranged in a second row. The second row of second series 114b is spaced from the row of series 114a. In some embodiments, the second row of second series 114b is substantially parallel to the row of series 114a. Thus, the second row of second series 114b extends in the first direction. Individual light sources of series 114a and/or second series 114b are spaced from one another such that the light sources are dispersed (e.g., evenly dispersed) along the length and/or width of display device 130. In some embodiments, series 114a and second series 114b comprise the same number of individual light sources. In the embodiment shown in FIG. 8, display device 400 comprises a third series 114c of light sources directly adjacent to second series 114b, a fourth series 114d of light sources directly adjacent to third series 114c, and a fifth series 114e of light sources directly adjacent to fourth series 114d. Each series of light sources is arranged in a row. In some embodiments, the rows are substantially parallel to one another. Additionally, or alternatively, the spacing between directly adjacent rows is substantially constant.

In some embodiments, display device 400 comprises multiple collimating units. For example, in the embodiment shown in FIG. 8, display device 400 comprises a collimating unit disposed adjacent to each series of light sources. Thus, the light emitted by each series of light sources is collimated and/or diffused by the corresponding collimating unit as described herein with reference to series 114a of light sources and collimating unit 120. In some embodiments, multiple collimating units are adjacent portions of a unitary collimating sheet as shown in FIG. 8. Such a unitary collimating sheet can be formed using a microreplication process, an embossing process, or another suitable forming process.

In some embodiments, diffusing unit 424 comprises a diffusing sheet as shown in FIG. 8. Such a diffusing sheet can be disposed adjacent to multiple series of light sources to diffuse the light emitted by each of the multiple series of light sources as described herein.

Although display device 400 is described as comprising five series of light sources arranged in five rows, other embodiments are included in this disclosure. In other embodiments, the display device comprises a determined number (e.g., one, two, three, four, six, or more) of series of light sources arranged in rows. Each series of light sources comprises a determined number (e.g., two, three, four, or more) of individual light sources. In some embodiments, the focal length of the optical elements of the aesthetic surface unit divided by the focal length of the collimating unit, is approximately equal to the size of the apertures of the aesthetic surface unit divided by the size of the light sources of the light unit. Such a relationship can be used to determine the number and/or placement of light sources.

In some embodiments, the light unit comprises end walls disposed at either end of the series of light sources. For example, the end walls extend substantially perpendicular to the series of light sources at each end thereof. In some embodiments, the end walls comprise reflective interior surfaces (e.g., facing inward into the display device). Such reflective interior surfaces can reflect light into the display device to avoid areas of reduced brightness at the edges of the display device.

Although both 1-dimensional and 2-dimensional designs are described herein, the 1-dimensional design may be advantageous in some applications. For example, the 1-dimensional design may be relatively less complex to manufacture (e.g., as a result of simpler optics and/or less stringent alignment tolerances between various components of the display device). Additionally, or alternatively, the 1-dimensional diffusing unit can enable “scrambling” of the optical phase of the incoming light, which can help to prevent interference that could otherwise create strong spatial non-uniformities after light is passed through a set of equidistant apertures.

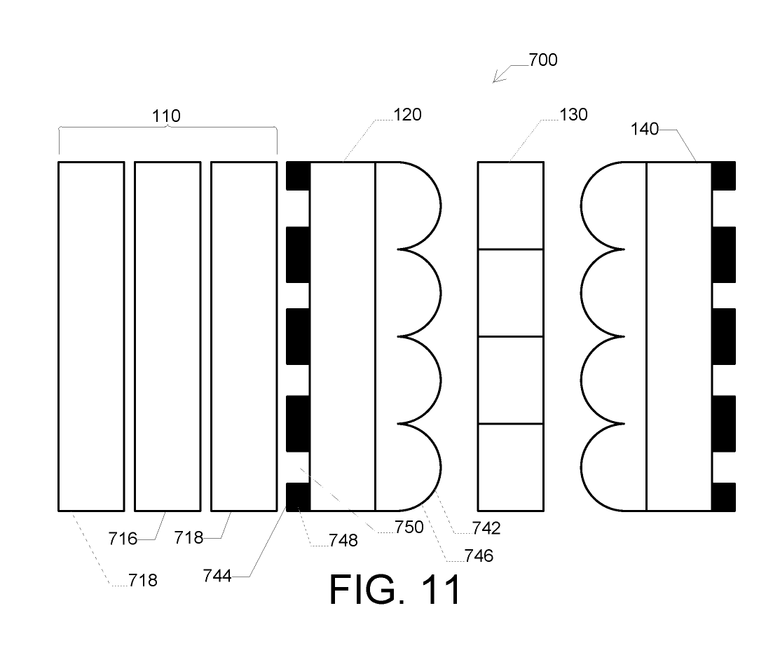

FIG. 11 is a schematic view of an exemplary display device 700. Display device 700 is similar to display device 100 described in reference to FIG. 1 and display device 400 described in reference to FIG. 8. For example, display device 700 comprises a light unit, image display unit 130, and aesthetic surface unit 140. The light unit comprises light emitting unit 110 and collimating unit 120.

In some embodiments, light emitting unit 110 comprises one or more light sources. For example, in the embodiment shown in FIG. 11, light emitting unit 110 comprises a light guide 716 and one or more light sources positioned to inject light into an edge of the light guide. In some embodiments, light guide 716 is configured as a light guiding sheet. Light guide 716 is configured to guide the light injected into the edge and emit the light from at least one surface of the light guide. Light guide 716 comprises a glass substrate, a polymer substrate, an air gap, or another suitable light guiding apparatus. In some embodiments, the one or more light sources is configured as a light bar comprising a plurality of LEDs or OLEDs disposed adjacent to an edge of the light guide.

In some embodiments, light emitting unit 110 comprises a reflective diffusing unit 718. Reflective diffusing unit 718 is configured to reflect and diffuse light at one surface of light guide 716 and direct the reflected and diffused light toward an opposite surface of the light guide. For example, in the embodiment shown in FIG. 11, reflective diffusing unit 718 comprises a substrate disposed adjacent to a first surface of light guide 716 to reflect and diffuse light emitted from the first surface and direct the reflected and diffused light into the light guide and toward a second surface opposite the first surface. In other embodiments, the first surface of the light guide can serve as the reflective diffusing unit. For example, a coating and/or surface treatment (e.g., surface roughening) can be applied to the first surface of the light guide to serve as the reflective diffusing unit. In some embodiments, the first surface of the light guide is coated with a reflective coating (e.g., a white or mirrored coating) and/or roughened to serve as the reflective diffusing unit. The reflective diffusing unit can help to increase the amount of light directed toward the second surface of the light guide to be emitted to generate an image for viewing by a viewer.

In some embodiments, light emitting unit 110 comprises a brightness enhancing unit 719. Brightness enhancing unit 719 is configured to collect light at one surface of light guide 716 and direct the light away from the light guide. For example, in the embodiment shown in FIG. 11, brightness enhancing unit 719 comprises a brightness enhancing film disposed adjacent to the second surface of light guide 716. Thus, light guide 716 is disposed between reflective diffusing unit 718 and brightness enhancing unit 719. Brightness enhancing unit 719 comprises a brightness enhancing film (BEF) a double brightness enhancing film (DBEF), or another suitable brightness enhancing structure.

Collimating unit 120 is disposed adjacent to light emitting unit 110. Collimating unit 120 is configured to collimate the light emitted by light emitting unit 110 in at least one direction. In the embodiment shown in FIG. 11, collimating unit 120 comprises a contrast enhancement unit that is similar to aesthetic surface unit 140, but modified as described below. For example, collimating unit 120 comprises a first major surface 742 and a second major surface 744 opposite the first major surface. First major surface 742 comprises an array of optical elements 746. Array of optical elements 746 can be configured as described herein with respect to the array of optical elements 146. In some embodiments, array of optical elements 746 comprises an array of collimating lenses (e.g., cylindrical lenses, Fresnel lenses, cylindrical Fresnel lenses, or combinations thereof). Second major surface 744 comprises a light reflecting layer 748 and an array of apertures 750 in the light reflecting layer. Light reflecting layer 748 comprises a reflective material (e.g., a white or mirrored layer). Array of apertures 750 can be configured as described herein with respect to array of apertures 150. Array of apertures 750 corresponds to the array of optical elements 746. For example, each optical element 746 is aligned with at least one aperture 750. Collimating unit 120 is reversed compared to aesthetic surface unit 140. For example, collimating unit 120 is disposed adjacent to light emitting unit 110 such that light emitted from the light emitting unit is incident on second surface 148 of the collimating unit. Thus, second surface 148 comprises an inlet surface, and first surface 744 comprises an outlet surface. Collimating unit 120 and light emitting unit 110 are arranged such that light reflecting layer 748 is disposed between the light emitting unit and array of optical elements 746.

In the embodiment shown in FIG. 11, the array of apertures comprises an array of elongate apertures extending in the first direction, and array of optical elements 746 comprises an array of lenticular lenses extending in the first direction. Thus, the first direction is aligned with the length of the elongate apertures and/or the longitudinal axis of the lenticular lenses. Light emitted from the second surface of light guide 716 contacts second surface 744 of collimating unit 120. Light that contacts second surface 744 at an aperture of light reflecting layer 748 passes through the light reflecting layer to be focused by an optical element and directed toward image display unit 130 and/or aesthetic surface unit 140. The remaining light that contacts second surface 744 is reflected by light reflecting layer 748 into light guide 716. Thus, light can be recycled into light guide 716 until allowed through an aperture of collimating unit 120. Collimating unit 120 is configured to collimate the light emitted from light guide 716 (e.g., by forcing the light through relatively narrow apertures). Additionally, or alternatively, brightness enhancing unit 719 can help to ensure that only the proper polarization passes through the apertures. Collimating unit 120 with elongate apertures and lenticular lenses as described herein is configured to collimate the light in the second direction (e.g., perpendicular to the apertures and lenticular lenses) without collimating the light in the first direction (e.g., parallel to the apertures and lenticular lenses). Thus, collimating unit 120 can be configured as a 1-dimensional collimating unit. Because light emitting unit 110 shown in FIG. 11 comprises reflective diffusing unit 718, the light emitted by collimating unit 120 can be diffused in the first direction without using an additional diffusing unit.

Although array of optical elements 146 and array of optical elements 746 are shown in FIG. 11 as having the same pitch, other embodiments are included in this disclosure. In other embodiments, the arrays of optical elements can have the same or different pitches, the same or different shapes, and the same or different sizes. Although array of apertures 150 and array of apertures 750 are shown in FIG. 11 as having the same pitch, other embodiments are included in this disclosure. In other embodiments, the arrays of apertures can have the same or different pitches, the same or different shapes, and the same or different sizes.

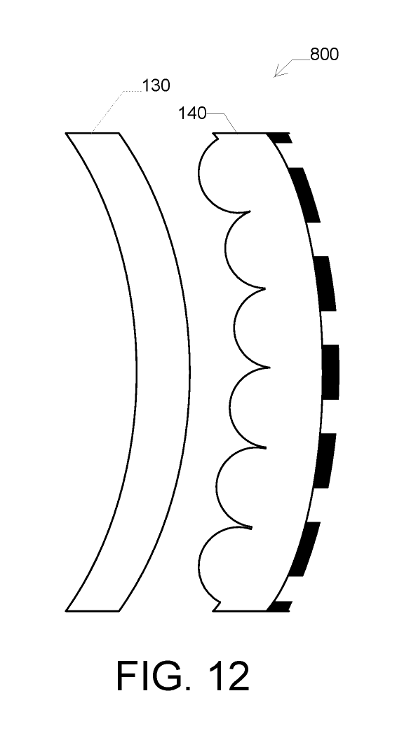

FIG. 12 is a schematic view of an exemplary display device 800. Display device 800 is similar to display device 100 described in reference to FIG. 1, display device 400 described in reference to FIG. 8, and display device 700 described in reference to FIG. 11. For example, display device 800 comprises image display unit 130 and aesthetic surface unit 140. In the embodiment shown in FIG. 12, image display unit 130 comprises an emissive image display unit. Because the image display unit is configured to emit light, the light unit is omitted. For example, image display unit 130 comprises a plurality of pixels arranged in a 2-dimensional array. Each pixel comprises one or more emissive elements (e.g., OLEDs). For example, each pixel comprises a red, a green, and a blue emissive element (e.g., sub-pixels) such that the pixel is configured to emit visible light having a desired color.

Aesthetic surface unit 140 can comprise a non-planar shape. For example, in the embodiment shown in FIG. 12, aesthetic surface unit 140 comprises a curved shape. Such a non-planar shape can enable the exterior surface of the display device to be integral with or form a portion of a surface (e.g., a vehicle surface) as described herein.

Although FIG. 12 shows image display unit 130 and aesthetic surface unit 140 having substantially the same non-planar shape, other embodiments are included in this disclosure. For example, in some embodiments, the image display unit is substantially planar, and the aesthetic surface unit is non-planar. In other embodiments, the image display unit and the aesthetic surface unit both are substantially planar or have different non-planar shapes.

Although FIGS. 1, 7, 10, and 11 show image display unit 130 and aesthetic surface unit 140 having substantially the same surface area, other embodiments are included in this disclosure. For example, in some embodiments, the image display unit has a smaller surface area that the aesthetic surface unit. In such embodiments, an image generated by the image display unit can be projected onto the aesthetic surface unit for transmission through the apertures in the aesthetic layer and viewing by a viewer.

Various components of the different embodiments described herein can be used in combination with one another. For example, collimating unit 120 shown in FIG. 11 can be used with light unit 110 shown in FIG. 8. Additionally, or alternatively, collimating unit 120 shown in FIG. 8 can be used with light unit 110 shown in FIG. 11. Additionally, or alternatively, aesthetic surface unit 240 shown in FIG. 6 or aesthetic surface unit 340 shown in FIG. 7 can be used with collimating unit 120 shown in FIG. 8 or collimating unit 120 shown in FIG. 11 and light unit 110 shown in FIG. 8 or light unit 110 shown in FIG. 11.

In some embodiments, a method for generating an image viewable directly by a viewer comprises emitting light, collimating the light in a second direction without collimating the light in a first direction perpendicular to the second direction, and diffusing the light in the first direction without diffusing the light in the second direction. In some embodiments, the emitting light comprises emitting Lambertian light having a substantially Lambertian intensity distribution in the second direction, and the method further comprises transforming the Lambertian light into uniform light having a substantially uniform intensity distribution in the second direction prior to the collimating the light in the second direction. In some embodiments, the method further comprises focusing the light onto an array of apertures of a light absorbing layer for viewing directly by the viewer.

In various embodiments, display devices described herein can be incorporated into vehicles such as automobiles, boats, and airplanes (e.g., mirrors, pillars, side panels of a door, headrests, dashboards, consoles, or seats of the vehicle, or any portions thereof), architectural fixtures or structures (e.g., internal or external walls or flooring of buildings), appliances (e.g., a refrigerator, an oven, a stove, a washer, a dryer, or another appliance), consumer electronics (e.g., televisions, laptops, computer monitors, and handheld electronics such as mobile phones, tablets, and music players), furniture, information kiosks, retail kiosks, and the like.

It will be apparent to those skilled in the art that various modifications and variations can be made without departing from the spirit or scope of the invention. Accordingly, the invention is not to be restricted except in light of the attached claims and their equivalents.

What is claimed is:

1. A display device comprising:
an image display unit;
an aesthetic layer comprising a matrix material and an array of apertures in the matrix material; and
a focusing layer disposed between the image display unit and the aesthetic layer and comprising an array of optical elements positioned to collectively focus an image generated by the image display unit through the array of apertures of the aesthetic layer.

2. The display device of claim 1, wherein an outer surface of the matrix material comprises a substantially solid color.

3. (canceled)

4. The display device of claim 1, wherein an outer surface of the matrix material comprises a decorative pattern.

5. The display device of claim 1, wherein:
the aesthetic layer comprises an inner layer and an outer layer;
the inner layer comprises the matrix material; and
the outer layer comprises a decorative layer.

6. The display device of claim 5, wherein the decorative layer comprises a substantially solid color.

7. (canceled)

8. The display device of claim 5, wherein the decorative layer comprises a decorative pattern.

9. The display device of claim 1, further comprising a translucent layer covering at least a portion of an outer surface of the aesthetic layer.

10. The display device of claim 1, wherein the aesthetic layer comprises a non-planar shape.

11. The display device of claim 1, wherein the image display unit comprises an array of point light sources.

12. The display device of claim 11, wherein the image display unit comprises a non-planar shape.

13. The display device of claim 1, wherein the image display unit comprises a backlight unit and an array of light valves, and the image display unit is positioned such that the array of light valves is between the backlight unit and the focusing layer.

14. The display device of claim 1, further comprising a diffusing layer disposed between the focusing layer and the aesthetic layer

15. The display device of claim 1, further comprising a diffusing material disposed within one or more of the apertures of the aesthetic layer.

16. The display device of claim 1, further comprising a light absorbing border disposed at an edge of one or more of the apertures of the aesthetic layer.

17. The display device of claim 16, wherein the light absorbing border extends at least partially around a circumference of the edge.

18. The display device of claim 1, wherein the apertures occupy at most about 50% of a surface area of the aesthetic layer.

19. The display device of claim 1, wherein a thickness of the aesthetic layer is at most about 125% of a size of the apertures.

20. A display device comprising:
an image display unit;
an aesthetic layer comprising an array of apertures therein, an outer surface of the aesthetic layer comprising a decorative surface; and
a focusing layer disposed between the image display unit and the aesthetic layer and comprising an array of optical elements positioned to collectively focus an image generated by the image display unit through the array of apertures of the aesthetic layer.

21. The display device of claim 20, wherein the aesthetic layer comprises a light absorbing layer, and
wherein the light absorbing layer is an inner layer and the aesthetic layer comprises an outer layer comprising the decorative surface.

22-29. (canceled)

30. A vehicle comprising the display device of claim 1.
